(19) United States
(12) Patent Application Publication
(10) Pub. No.: US 2009/0052899 A1
(43) Pub. Date: Feb. 26, 2009

(54) METHOD AND APPARATUS FOR CONTROLLED DEVICE SELECTION BY A PORTABLE ELECTRONIC DEVICE

(75) Inventors: Swee MOK, Palatine, IL (US); Zili Ll, Barrington, IL (US); Tom Schirtzinger, Fontana, WI (US); Chi Zhou, Vernon Hills, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/843,192

(22) Filed: Aug. 22, 2007

(51) Int. Cl. H04B 10/10

(52) U.S. Cl. 398/106

(57) ABSTRACT

The present application discloses a method and apparatus for controlled device selection by a portable electronic device (110). The method may include transmitting, from the portable electronic device, a first wireless signal (140) requesting information corresponding to remote controlled devices (132, 134, 136, 138), sending an optical signal (150) over the air to at least one remote controlled device, receiving a second wireless signal including information corresponding to at least one specific remote controlled device in response to sending the optical signal, adjusting settings, in response to receiving the second wireless signal, on the portable electronic device to enable remote control of at least one selected remote controlled device (134) of the at least one specific remote controlled device based on the information corresponding to the at least one specific remote controlled device.

### BACKGROUND

1. Field

The present disclosure is directed to a method and apparatus for controlled device selection by a portable electronic device. More particularly, the present disclosure is directed to selection of a controlled device by a portable electronic device using wireless and optical signals.

2. Introduction

Presently, programmable remote controls can be used to control controlled devices, such as multimedia devices, home appliances, and other devices. For example, a programmable remote control can be used to control a television, a cable box, and an audio/video receiver. To control a specific device a user can select a button designated for the specific device and then use other buttons on the remote control to control functions of the device. Unfortunately, such programmable remote controls need to be programmed separately for each controlled device. For example, a user may need to reference a manual to determine a code for a controlled device and manually enter a code after keying a designated sequence that tells the remote control it is about to be programmed. This is a tedious process which often requires trial and error to determine which codes are the correct codes for a specific controlled device.

Digital Living Network Alliance (DLNA) has an objective for the establishment of a wired and wireless interoperable network of personal computers, consumer electronics and mobile devices in the home and on the road. Unfortunately, universal plug and play devices do not allow a DLNA remote control to easily control controlled devices by merely pointing at a device. For example, a user must first select a device of interest from a list before attempting to control it. Consequently, DLNA remote controls still require a tedious process.

Thus, there is a need for an improved method and apparatus for controlled device selection by a portable electronic device.

### SUMMARY

The present application discloses a method and apparatus for controlled device selection by a portable electronic device. The method may include transmitting, from the portable electronic device, a first wireless signal requesting information corresponding to remote controlled devices, sending an optical signal over the air to at least one remote controlled device, receiving a second wireless signal including information corresponding to at least one specific remote controlled device in response to sending the optical signal, adjusting settings, in response to receiving the second wireless signal, on the portable electronic device to enable remote control of at least one selected remote controlled device of the at least one specific remote controlled device based on the information corresponding to at least one specific remote controlled device.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an exemplary block diagram of a system in accordance with one possible embodiment of the disclosure;

FIG. 2 is an exemplary block diagram of a portable electronic device in accordance with one possible embodiment of the disclosure;

FIG. 3 is an exemplary block diagram of a remote controlled device in accordance with one possible embodiment of the disclosure;

FIG. 4 is an exemplary flowchart illustrating the operation of a portable electronic device in accordance with one possible embodiment of the disclosure;

FIG. 5 is an exemplary flowchart illustrating the operation of a controlled device in accordance with one possible embodiment of the disclosure;

FIG. 6 is an exemplary illustration of optical signal exchange in accordance with one possible embodiment of the disclosure;

FIG. 7 is an exemplary illustration of reflector structure and operation in accordance with one possible embodiment of the disclosure;

FIG. 8 is an exemplary illustration of optical signal transmitter and optical signal receiver structure and operation in accordance with one possible embodiment of the disclosure;

FIG. 9 is an exemplary illustration of usage history determination for a portable electronic device in accordance with one possible embodiment of the disclosure; and

FIG. 10 is an exemplary flowchart illustrating the operation of a portable electronic device in accordance with one possible embodiment of the disclosure.

### DETAILED DESCRIPTION

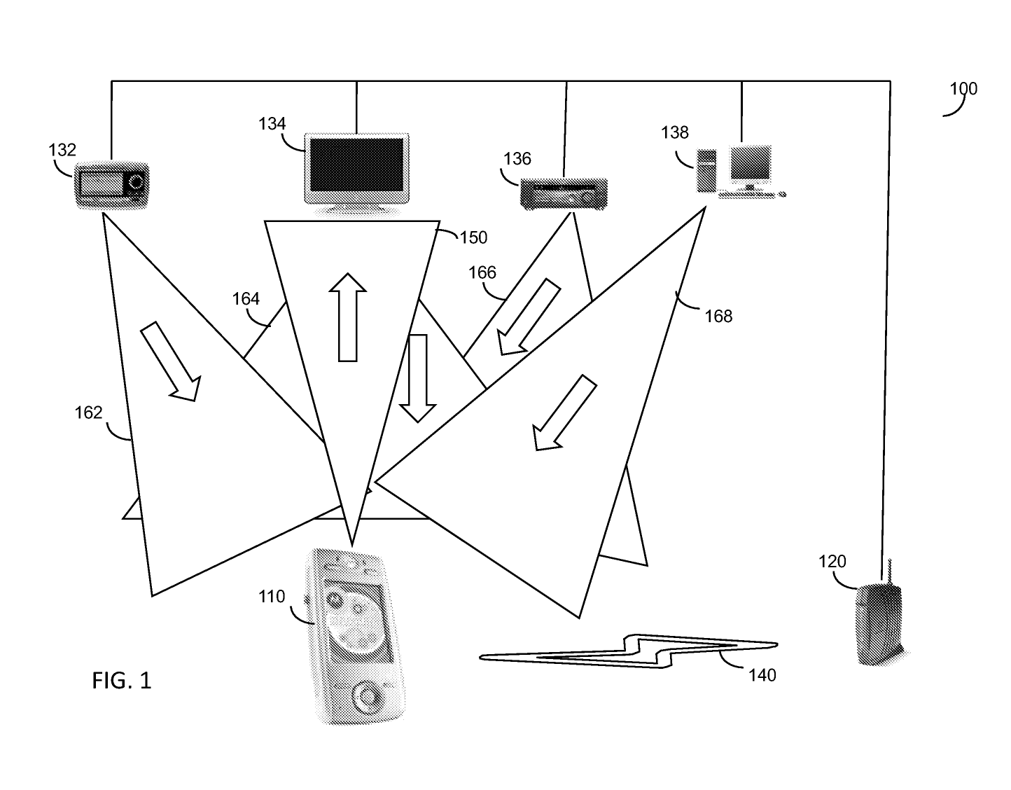

FIG. 1 is an exemplary block diagram of a system 100 according to one possible embodiment. The system 100 can include a portable electronic device 110, an access point 120, and controlled devices 132, 134, 136, and 138. The portable electronic device 110 may be a wireless communication device, such as a wireless telephone, a cellular telephone, a remote control, a personal digital assistant, a pager, a personal computer, a selective call receiver, or any other device that is capable of sending and receiving communication signals on a network including wireless network. The remote controlled devices may include a satellite receiver 132, a television, 134, a stereo receiver 136, a personal computer 138, a MP3 player, a DVD player, a CD, player, a home security system, or any other remote controlled device. The term “controlled device” refers to the fact that such a device may be controlled by a portable electronic device. Thus, the term includes devices that can be controlled, but may not yet be associated with a portable electronic device. The access point 120 may be a local access point, a wireless router, a base station, or any other access point. The portable electronic device 110 can be wirelessly coupled 140 to the access point 120. The controlled devices 132, 134, 136, and 138 can be coupled to the access point 120 via a wireless or wired coupling. The portable electronic device 110 can remotely control the controlled devices 132, 134, 136, and 138 by using radio frequency remote control signals over a wireless network, such as a local wireless network, by using infrared signals, or by any other means of remotely controlling a controlled device.

In operation, the portable electronic device 110 can transmit a first wireless signal to the access point 120. The wireless signal can include data requesting information corresponding to the remote controlled devices 132, 134, 136, and 138. The portable electronic device 110 can then send an optical signal 150 over the air to at least one remote controlled device 134. The portable electronic device 110 can then receive a second wireless signal from the access point 120, the second wireless signal including information corresponding to at least one specific remote controlled device 132, 134, and/or 136 in response to sending the optical signal 150. In response to receiving the second wireless signal, the portable electronic device 110 can then adjust settings on the portable electronic device 110 to enable remote control of at least one selected remote control device 134 of the at least one specific remote controlled device 132, 134, and/or 136 based on the information corresponding to at least one specific remote controlled device 132, 134, and/or 136.

According to another embodiment, the remote controlled devices 132, 134, 136, and 138 can send an optical signal 162, 164, 166, and 168 over the air to the portable electronic device 110 in response to receiving information corresponding to the first wireless signal, such as data requesting information corresponding to the remote controlled devices 132, 134, 136, and 138. The portable electronic device 110 can receive the optical signal and reflect the optical signal back to the remote controlled devices 132, 134, 136, and 138.

The teachings of the present disclosure can simplify the remote control operation of, for example, Digital Living Network Alliance (DLNA) and/or Universal Plug & Play (UPnP) multimedia devices. This can improve the user-experience. It can also simplify the task when a user wishes to control different devices because the portable electronic device 110 can predict desired devices and automatically set up a graphical user interface on the portable electronic device 110.

For example, according to a related embodiment, the present disclosure can provide a method to implement a low-cost, point-and-control mechanism for DLNA/UPnP devices that can also analyze a user's use-history to automatically customize the portable electronic device's user interface. Each device to be controlled can have an infrared transceiver. The portable electronic device 110 can have a retroreflector sticker, and a ‘Select’ button that can initiate a point-and-control process. The size of the optical signal ‘cone’ 150 for allowable incoming and reflected light can be designed to minimize false selection of a device while enabling a small angle from perpendicular to be tolerated.

According to a related embodiment, point-and-control can take about <<1 second. For point-and-control, a user can press a ‘Select’ button, and point to the device 134 of interest. The portable electronic device 110 can multicast/broadcast, for example, a Simple Service Discovery Protocol (SSDP) M-SEARCH command with a parameter requesting “reflected signal strength” (RSS). All of the devices to be controlled, such as DLNA devices, can then switch on their optical transceivers. After a set time all devices that support this feature can respond to the M-SEARCH request with their RSS as well as their unique identifiers (UIDs). After another set time, the portable electronic device's control point application can compare RRS levels received from all devices and identify the desired device's UID based on the signal strength. The portable electronic device 110 can then retrieve a presentation page and load it to the user interface as a remote control. The user can now control the desired device.

The portable electronic device 110 can also predict a user's needs and set up its graphical user interface automatically. Accordingly, the portable electronic device 110 can have multiple rows of programmable buttons that can be used to designate devices. Also, one or more rows may be dedicated to manual programming. Additional row(s) can be automatically programmed by the portable electronic device's prediction software. For example, the portable electronic device 110 can remember users' use pattern in a database in its memory. The use pattern/history can be used for predicting the next device the user will likely interact with. The prediction can be based on a use-pattern's frequency, time, location, etc. of occurrence. A set of rules linking related devices can also be programmed to help with device prediction.

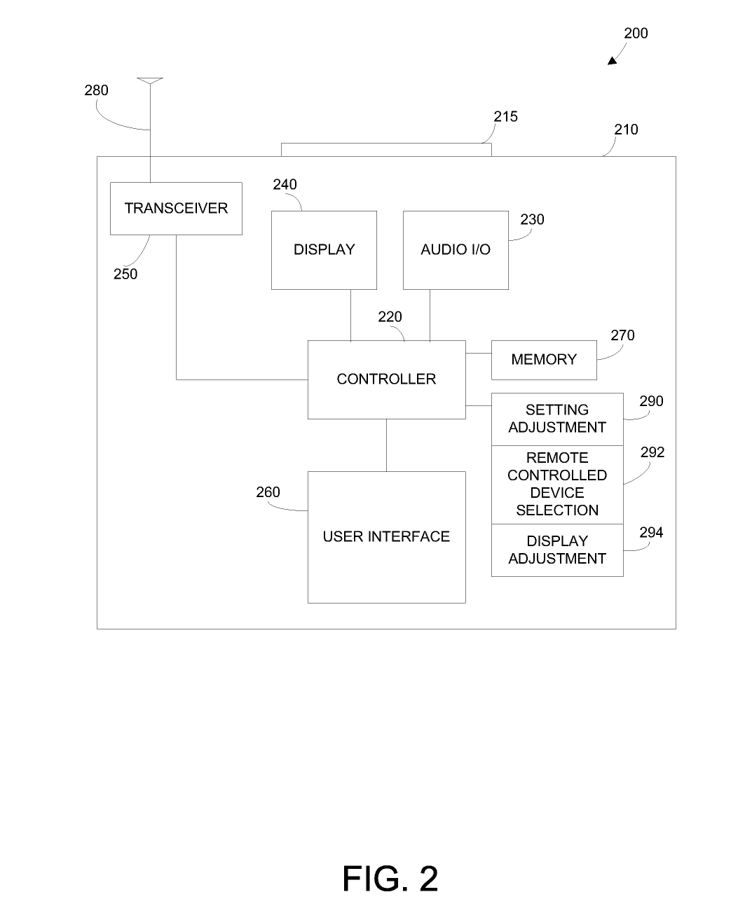

FIG. 2 is an exemplary block diagram of a portable electronic device 200, such as the portable electronic device 110, according to one embodiment. The portable electronic device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and an optical signal transmitting device 215 coupled to the housing. The portable electronic device 200 can also include a setting adjustment module 290, a remote controlled device selection module 292, and a display adjustment module 294. The setting adjustment module 290, the remote controlled device selection module 292, and the display adjustment module 294 can be coupled to the controller 220, can reside within the controller 220, can reside within the memory 270, can be autonomous modules, can be software, can be hardware, or can be in any other format useful for a module on a portable electronic device 200.

The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory, a subscriber identity module memory, or any other memory that can be coupled to a wireless communication device. The optical signal transmitting device 215 can be a reflector or a light transmitter such as a light source, a light emitting diode, an infrared transmitter, or any other light transmitter.

In operation, the controller 220 can control the operations of the portable electronic device 200. The transceiver 250 can transmit a first wireless signal requesting information corresponding to remote controlled devices. The optical signal transmitting device 215 can transmit an optical signal to the at least one remote control device. The transceiver 250 can receive a second wireless signal including information corresponding to at least one specific remote controlled device. The setting adjustment module 290 can adjust settings, in response to receiving the second wireless signal, on the portable electronic device 200 to enable remote control of at least one selected remote control device of the at least one specific remote controlled device based on the information corresponding to the at least one specific remote controlled device. According to one embodiment, the optical signal transmitting device 215 can be a reflector coupled to the housing. Thus, the optical signal transmitting device 215 can receive an optical signal from at least one remote controlled device in response to transmitting the first wireless signal and reflect the optical signal back to the at least one remote controlled device. The remote controlled device selection module 292 can determine a strongest received reflected optical signal at a plurality of remote controlled devices based on an indicator of signal strength in the second wireless signal. The remote controlled device selection module 292 can then select the at least one selected remote controlled device using a unique identification number of the at least one selected remote controlled device. The display adjustment module 294 can track the usage history of the portable electronic device 200 and adjust the display 240 of the portable electronic device 200 based on usage history of the portable electronic device 200. The display adjustment module 294 can establish the usage history by tracking a pattern of usage of remote controlled devices and predicting usage of related remote controlled devices based on a set of rules that link the related remote controlled devices. For example, the display adjustment module 294 can dedicate at least one first icon on a user interface, such as the display 240, to a user selected icon for a remote controlled device and automatically set at least one second icon on the user interface based on the predicted usage of related remote controlled devices.

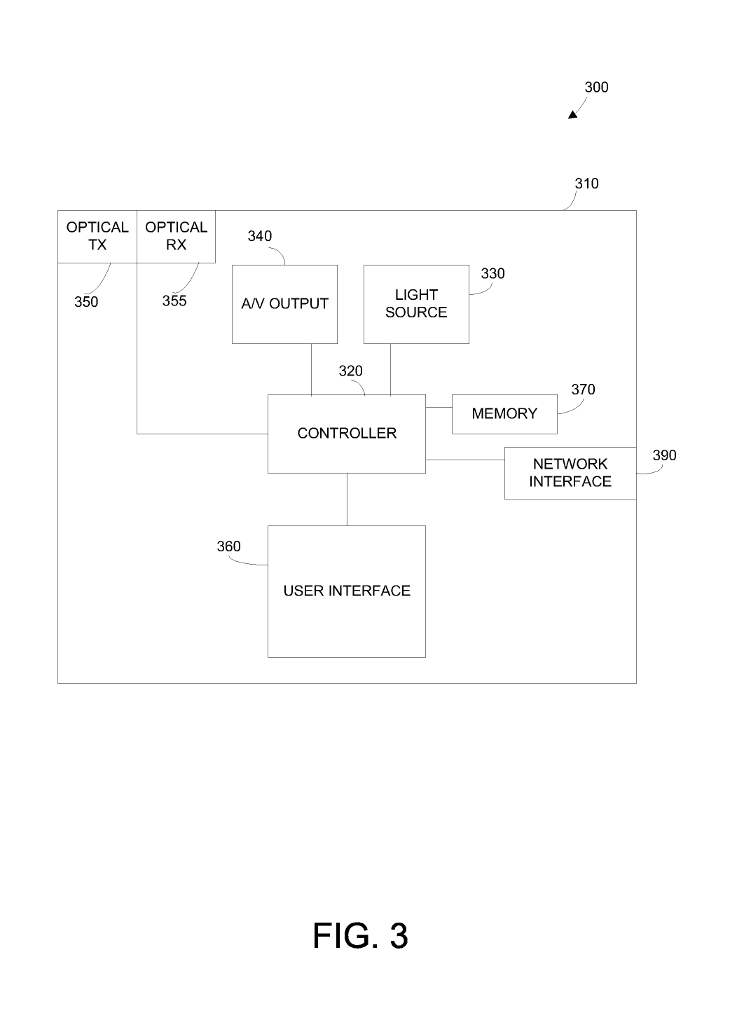

FIG. 3 is an exemplary block diagram of a remote controlled device 300, such as one of the remote controlled devices 132, 134, 136, and/or 138, according to one embodiment. The remote controlled device 300 can include a housing 310, a controller 320 coupled to the housing 310, a light source 330 coupled to the housing, audio/video output 340 coupled to the housing 310, an optical transmitter 350 coupled to the housing 310, an optical receiver 355 coupled to the housing 310, a user interface 360 coupled to the housing 310, a memory 370 coupled to the housing 310, and network interface 390 coupled to the housing and to the controller 320.

The light source 330 can be a light emitting diode (LED), an incandescent light, a plasma light source, or any other light source. The optical transmitter may be a LED, an infrared light source, a plasma light source, or any other optical transmitter. The audio/visual output 340 can be a plasma display, a LED display, a cathode ray tube (CRT) display, speakers, or any other audio visual output. The memory 370 may include a random access memory, a read only memory, an optical memory, or any other memory. The network interface 390 can be a wired network interface, a local area network interface, such as a wireless local area network interface, an Ethernet network interface, a wireless network interface, a Bluetooth transmitter/receiver, an 802.11 transmitter/receiver, or any other network interface.

In operation, the controller 320 can control the operations of the remote controlled device 300. The network interface 390 can send and receive data to and from a network. For example, the network interface 390 can receive information corresponding to a wireless signal, the information indicating a detection attempt of the remote controlled device 300. The information corresponding to the wireless signal can be included in a wireless signal sent from the portable electronic device 110 to obtain information about the remote controlled device 300. The optical signal receiver 355 can receive an optical signal corresponding to the detection attempt. The network interface 390 can then transmit control information corresponding to the remote controlled device 300 in response to receiving the optical signal.

According to another embodiment, the optical signal transmitter 350 can transmit an optical signal in response to the network interface 390 receiving a connection attempt message. The optical signal receiver 355 can then receive a reflection of the transmitted optical signal and the network interface 390 can transmit control information corresponding to the remote controlled device 300 in response to receiving the reflection of the optical signal.

The control information can include signal strength information. The signal strength information can be based on a strength of the received optical signal. The controller 320 can illuminate the light source 330 in response to receiving the optical signal. The controller 320 may vary the intensity of the light source 330 based on the strength of the received optical signal.

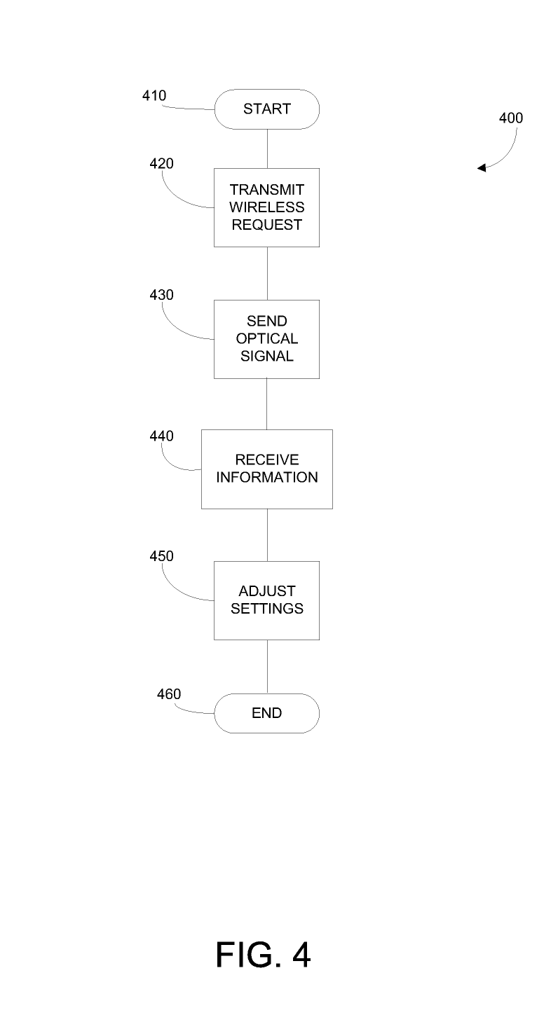

FIG. 4 is an exemplary flowchart 400 illustrating the operation of the portable electronic device 110 according to another embodiment. In step 410, the flowchart begins. In step 420, the portable electronic device 110 can transmit a first wireless signal requesting information corresponding to remote controlled devices. In step 430, the portable electronic device 110 can send an optical signal over the air to at least one remote controlled device. In step 440, the portable electronic device 110 can receive a second wireless signal including information corresponding to at least one specific remote controlled device in response to sending the optical signal. In step 450, the portable electronic device 110 can adjust settings, in response to receiving the second wireless signal, on the portable electronic device 110 to enable remote control of at least one selected remote control device of the at least one specific remote controlled device based on the information corresponding to at least one specific remote controlled device. In step 460, the flowchart ends.

The portable electronic device 110 can send the optical signal 430 by receiving an optical signal over the air from at least one remote controlled device in response to transmitting the first wireless signal and reflecting the optical signal back to the at least one remote controlled device. The first wireless signal can be a radio-frequency signal, the second wireless signal can be a radio-frequency signal, and the optical signal can be an infrared signal. The infrared signal can be modulated within a range of frequencies to enable the devices to more easily discriminate an intended signal from ambient infrared noise

The received second wireless signal can include an indicator of a signal strength of the reflected optical signal at the at least one specific remote controlled device. For example, the received second wireless signal may comprise multiple messages, each for different remote controlled devices or may comprise one message including signal strengths for multiple remote controlled devices. The portable electronic device 110 can adjust settings by determining a strongest signal among a plurality of remote controlled devices based on the indicator of signal strength to select the at least one selected remote controlled device using a unique identification number of the at least one selected remote controlled device.

The first wireless signal can be a multicast wireless signal including a command with a parameter requesting reflected signal strength. The command can be a simple service discovery protocol multiple device search command.

The portable electronic device 110 can adjust settings 450 by retrieving a control interface for the at least one selected remote controlled device and loading the control interface for the at least one selected remote controlled device into a user interface for remote control of the at least one selected remote controlled device. A control interface may be a user interface, a presentation page, a UPnP control point, a remote user interface (RUI) control point, an executer of an installed application, or any other control interface.

The portable electronic device 110 can adjust settings 450 by adjusting a display of the portable electronic device 110 based on usage history of the portable electronic device 110. The portable electronic device 110 can establish the usage history by tracking a pattern of usage of remote controlled devices and predicting usage of related remote controlled devices based on a set of rules that link the related remote controlled devices. The rules may be based on time, location, frequency, etc. of use.

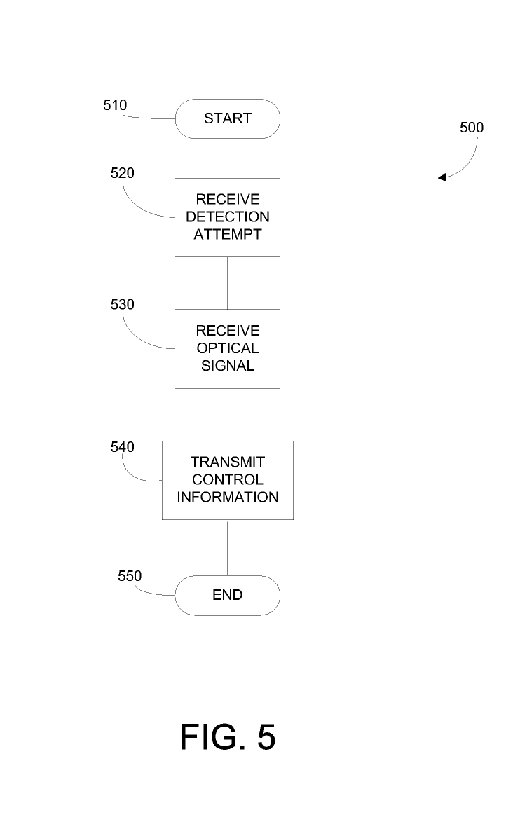

FIG. 5 is an exemplary flowchart 500 illustrating the operation of the remote controlled device 300 according to another embodiment. In step 510, the flowchart begins. In step 520, the remote controlled device 300 can receive information corresponding to a wireless signal, the information indicating a detection attempt of the remote controlled device 300. In step 530, the remote controlled device 300 can receive an optical signal over the air, the optical signal related to the wireless signal. For example, the optical signal can be related to the wireless signal because it is being used for the detection attempt associated with the wireless signal. In step 540, the remote controlled device 300 can transmit control information corresponding to the remote controlled device 300 in response to receiving the optical signal.

According to a related embodiment, the remote controlled device 300 can receive a detection attempt 520 by transmitting an optical signal in response to receiving the information indicating a detection attempt and receiving a reflection of the optical signal over the air, the optical signal related to the wireless signal. The remote controlled device 300 can then transmit the control information 540 by transmitting control information corresponding to the remote controlled device in response to receiving the reflection of the optical signal.

The remote controlled device 300 can transmit control information 540 by transmitting signal strength information, the signal strength information based on a strength of the received reflection of the optical signal. While receiving the optical signal, the remote controlled device 300 can illuminate a light source in response to receiving the reflection of the optical signal. The light source can be illuminated at an illumination level corresponding to a signal strength of the received reflection of the optical signal. For example, the controlled device 300 can illuminate a LED to indicate reception of the reflection of the optical signal if a signal strength of the received optical signal is above a threshold.

The information corresponding to a wireless signal can include a multiple device search command. The remote controlled device 300 can transmit control information by transmitting a unique identifier of the remote controlled device 300 and a received signal strength based on the received optical signal.

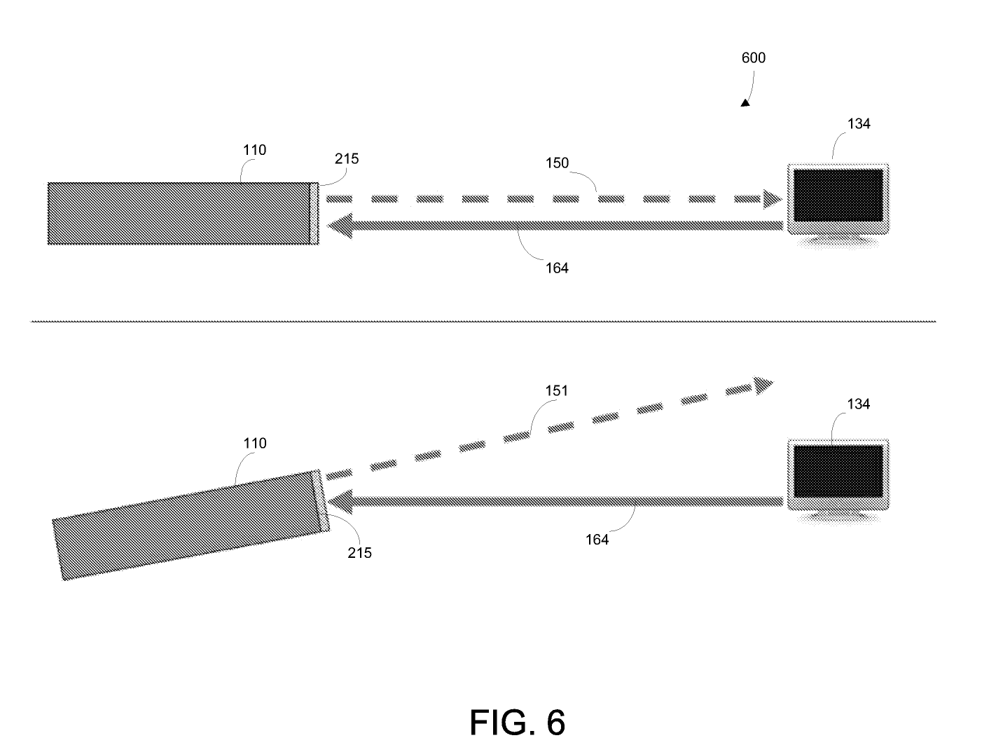

FIG. 6 is an exemplary illustration 600 of optical signal exchange in accordance with a possible embodiment of the disclosure. As shown, a device to be controlled, such as the controlled device 134, can transmit an optical signal 164 to the portable electronic device 110. The portable electronic device 110 can use the reflector 215 to reflect the optical signal 150. If the portable electronic device 110 is facing the controlled device 134, the reflected optical signal 150 will be reflected at the controlled device 134. However, if the portable electronic device 110 is not facing the controlled device 134, the reflected optical signal 151 will not be directly reflected at the controlled device 134. Thus, the controlled device 134 can determine if it is the desired device to be controlled depending on whether the controlled device 134 receives the reflected optical signal based on the portable electronic device 110 facing the controlled device 134.

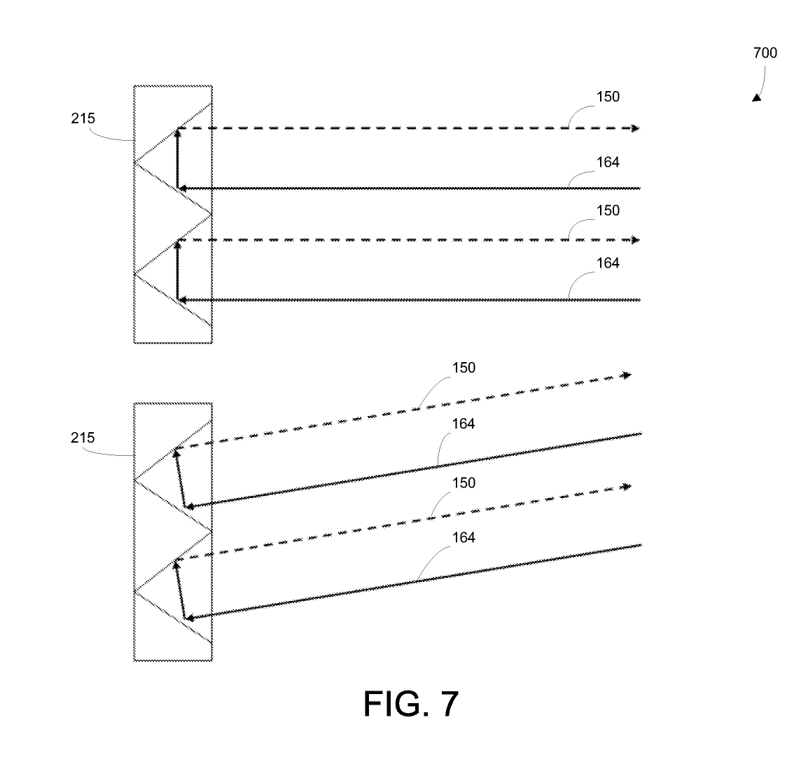

FIG. 7 is an exemplary illustration 700 of reflector 215 structure and operation in accordance with a related embodiment of the disclosure. As shown, reflective surfaces within the reflector 215 can be used to more accurately reflect the transmitted optical signal 164 back as the reflected optical signal 150 substantially in the direction from which the transmitted optical signal was received.

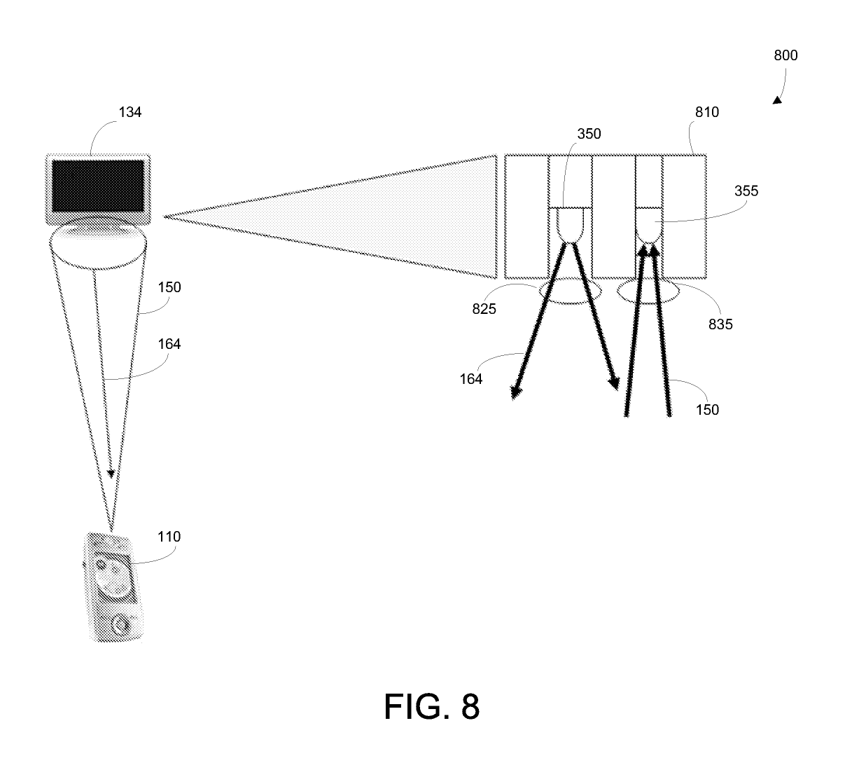

FIG. 8 is an exemplary illustration 800 of optical signal transmitter 350 and optical signal receiver 355 structure and operation in accordance with a related embodiment of the disclosure. As shown, the optical signal transmitter 350 can transmit an optical signal 164 to the portable electronic device 110. The optical signal transmitter 350 may use a filter or lens 825 to control the direction and covered area in which the optical signal 164 is transmitted. The portable electronic device 110 can reflect the optical signal 150 back to the optical signal receiver 355. The optical signal receiver 355 may also use a filter or lens 835 to control the direction and covered area in which the optical signal 164 is received.

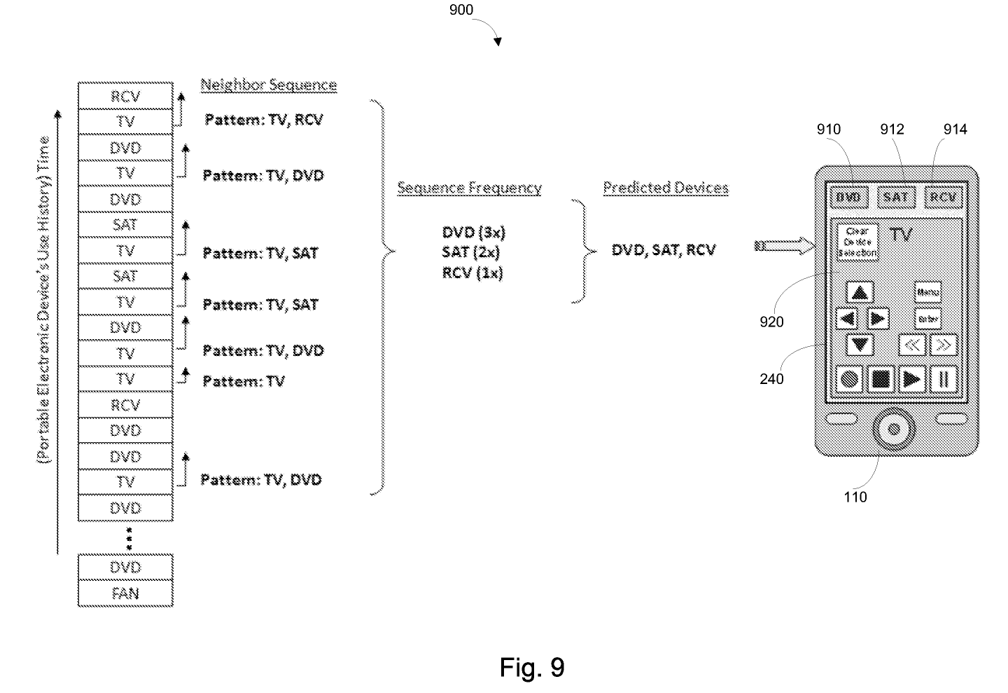

FIG. 9 is an exemplary illustration of usage history determination 900 for the portable electronic device 110 in accordance with a related embodiment of the disclosure. The portable electronic device 110 can include a touch screen that allows user input by touching graphics on the display 240. Using an automatic determination from an algorithm, the portable electronic device 110 can present graphics representing the devices 910, 912, and 914 on the display 240. The portable electronic device 110 can also present control graphics 920, such as a control pad, for controlling a currently selected device, such as a television device 134. When the device 134 is selected, the algorithm can predict one or more predicted devices 910, 912, 914 that a user may subsequently use. To select the predicted devices, the portable electronic device 110 can scan a sequence history of the current selected device 134. The portable electronic device 110 can then pick out the neighbors of selected device 134 as candidates for predicted devices. The portable electronic device 110 can then calculate frequency of selection of predicted devices. The portable electronic device 110 can then select devices with highest frequency of occurrence. Then portable electronic device 110 can then display the predicted devices 910, 912, and 914 on the display 240.

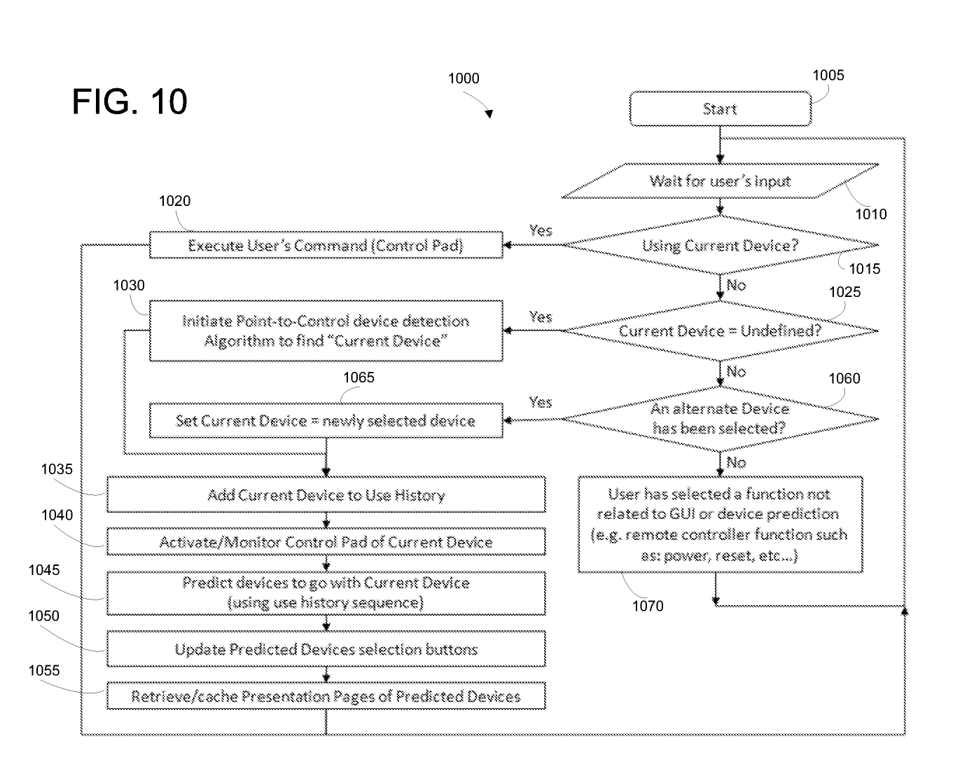

FIG. 10 is an exemplary flowchart 1000 illustrating the operation of a portable electronic device 110 in accordance with another possible embodiment of the disclosure. The flowchart 1000 can show user interactions and device prediction on the portable electronic device 110. In step 1005, the flowchart begins. In step 1010, the portable electronic device 110 can wait for user input. In step 1015, the portable electronic device 110 can determine if the user will be using the currently selected device. If so, in step 1020, the portable electronic device 110 can execute the user's command on the control pad 920 and return to step 1010. If the answer to step 1015 is no, in step 1025, the portable electronic device 110 can determine if the current device is an undefined device. If so, in step 1030, the portable electronic device 110 can initiate a point-to-control device detection algorithm to find the current device. For example, the portable electronic device 110 can operate in accordance with the flowchart 400 in FIG. 4. Then, in step 1035, the portable electronic device 110 can add the current device to a usage history in the memory of the portable electronic device 110. In step 1040, the portable electronic device 110 can activate and monitor the control pad of the current device 920. In step 1045, the portable electronic device 110 can predict devices to go with the current device using a usage history sequence, such as the one illustrated in FIG. 9. In step 1050, the portable electronic device 110 can update the predicted device selection buttons 910, 912, and 914 based on the usage history. In step 1055, the portable electronic device 110 can retrieve and cache presentation pages of the predicted devices for use on the control pad 920 and return to step 1010. If the answer to step 1025 is no, in step 1060 the portable electronic device 110 can determine if an alternate device has been selected. If so, in step 1065, the portable electronic device 110 can set the current device to be the newly selected device and advance to step 1035. If the answer to step 1060 is no, in step 1070 the portable electronic device 110 can determine that the user has selected a function not related to the graphical user interface or device prediction. For example, the user may be using the control pad to operate the currently selected device. The portable electronic device 110 can then return to step 1010.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A method at a portable electronic device, the method comprising:
transmitting, from the portable electronic device, a first wireless signal requesting information corresponding to remote controlled devices;
sending an optical signal over the air to at least one remote controlled device;
receiving a second wireless signal including information corresponding to at least one specific remote controlled device in response to sending the optical signal; and
adjusting settings, in response to receiving the second wireless signal, on the portable electronic device to enable remote control of at least one selected remote controlled device of the at least one specific remote controlled device based on the information corresponding to the at least one specific remote controlled device.

2. The method according to claim 1, further comprising:
receiving an optical signal over the air from at least one remote controlled device in response to transmitting the first wireless signal,
wherein sending comprises reflecting the optical signal back to the at least one remote controlled device.

3. The method according to claim 1, wherein the first wireless signal comprises a radio-frequency signal, wherein the second wireless signal comprises a radio-frequency signal, and wherein the optical signal comprises an infrared signal.

4. The method according to claim 2, wherein the received second wireless signal includes indicator of a signal strength of the reflected optical signal at the at least one specific remote controlled device.

5. The method according to claim 4, further comprising determining a strongest signal among a plurality of remote controlled devices based on the indicator of signal strength to select the at least one selected remote controlled device using a unique identification number of the at least one selected remote controlled device.

6. The method according to claim 2, wherein the first wireless signal comprises a multicast wireless signal including a command with a parameter requesting reflected signal strength.

7. The method according to claim 6, wherein the command comprises a simple service discovery protocol multiple device search command.

8. The method according to claim 1, further comprising:
retrieving a control interface for the at least one selected remote controlled device; and
loading the control interface for the at least one selected remote controlled device into a user interface for remote control of the at least one selected remote controlled device.

9. The method according to claim 1, further comprising adjusting a display of the portable electronic device based on usage history of the portable electronic device.

10. The method according to claim 9, further comprising establishing the usage history by tracking a pattern of usage of remote controlled devices and predicting usage of related remote controlled devices based on a set of rules that link the related remote controlled devices.

11. A method at a remote controlled device, the method comprising:
receiving, at the remote controlled device, information corresponding to a wireless signal, the information indicating a detection attempt of the remote controlled device;
receiving an optical signal over the air, the optical signal related to the wireless signal;
transmitting control information corresponding to the remote controlled device in response to receiving the optical signal.

12. The method according to claim 11, further comprising transmitting an optical signal in response to receiving the information indicating a detection attempt,
wherein receiving an optical signal comprises receiving a reflection of the optical signal over the air, the optical signal related to the wireless signal, and
wherein transmitting control information comprises transmitting control information corresponding to the remote controlled device in response to receiving the reflection of the optical signal.

13. The method according to claim 11, further comprising transmitting signal strength information, the signal strength information based on a strength of the received reflection of the optical signal.

14. The method according to claim 11, further comprising illuminating a light source in response to receiving the reflection of the optical signal.

15. The method according to claim 14, wherein the light source is illuminated at an illumination level corresponding to a signal strength of the received reflection of the optical signal.

16. The method according to claim 11,
wherein the information corresponding to a wireless signal includes a multiple device search command, and
wherein transmitting control information includes transmitting a unique identifier of the remote controlled device and a received signal strength based on the received optical signal.

17. A portable electronic device, comprising:
a housing;
a controller coupled to the housing, the controller configured to control the operations of the portable electronic device;
a transmitter coupled to the controller, the transmitter configured to transmit a first wireless signal requesting information corresponding to remote controlled devices;
an optical signal transmitting device coupled to the housing, the optical signal transmitting device configured to transmit an optical signal to the at least one remote control device;
a receiver coupled to the controller, the receiver configured to receive a second wireless signal including information corresponding to at least one specific remote controlled device; and
a setting adjustment module configured to adjust settings, in response to receiving the second wireless signal, on the portable electronic device to enable remote control of at least one selected remote controlled device of the at least one specific remote controlled device based on the information corresponding to the at least one specific remote controlled device.

18. The portable electronic device according to claim 17, wherein the optical signal transmitting device comprises a reflector coupled to the housing, the reflector configured to receive an optical signal from at least one remote controlled device in response to transmitting the first wireless signal and reflect the optical signal back to the at least one remote controlled device.

19. The portable electronic device according to claim 18, further comprising a remote controlled device selection module configured to determine a strongest received reflected optical signal at a plurality of remote controlled devices based on an indicator of signal strength in the second wireless signal and configured to select the at least one selected remote controlled device using a unique identification number of the at least one selected remote controlled device.

20. The portable electronic device according to claim 17, further comprising a display adjustment module configured to track the usage history of the portable electronic device and adjust a display of the portable electronic device based on usage history of the portable electronic device.

21. A remote controlled device, comprising:
a housing;
a controller coupled to the housing, the controller configured to control the operations of the remote controlled device;
a network interface coupled to the controller, the network interface configured to send and receive data to and from a network, the network interface configured to receive information corresponding to a wireless signal, the information indicating a detection attempt of the remote controlled device;
an optical signal receiver configured to receive an optical signal corresponding to the detection attempt,
wherein the network interface is configured to transmit control information corresponding to the remote controlled device in response to receiving the optical signal.

22. The remote controlled device according to claim 21, further comprising an optical signal transmitter coupled to the controller, the optical signal transmitter configured to transmit an optical signal in response to the network interface receiving a connection attempt message,
wherein the an optical signal receiver is configured to receive a reflection of the transmitted optical signal, and
wherein the network interface is configured to transmit control information corresponding to the remote controlled device in response to receiving the reflection of the optical signal.

23. The remote controlled device according to claim 21, wherein the control information includes signal strength information, the signal strength information based on a strength of the received optical signal.

24. The remote controlled device according to claim 21, further comprising a light source coupled to the controller, wherein the controller is configured to illuminate the light source in response to receiving the optical signal.
